(19) United States
(12) Patent Application Publication
(10) Pub. No.: US 2013/0163222 A1
(43) Pub. Date: Jun. 27, 2013

(54) ILLUMINATION MODULE

(71) Applicants: Dongguan Masstop Liquid Crystal Display Co., Ltd, Dongguan City (CN); Wintek Corporation, Taichung City (TW)

(72) Inventors: Zhi-Ting Ye, Miaoli County (TW); Chin-Liang Chen, Taichung City (TW); Ming-Chuan Lin, Taichung City (TW)

(73) Assignees: WINTEK CORPORATION, Taichung City (TW); DONGGUAN MASSTOP LIQUID CRYSTAL DISPLAY CO., LTD., Dongguan City (CN)

(21) Appl. No.: 13/706,459

(22) Filed: Dec. 6, 2012

(30) Foreign Application Priority Data
Dec. 26, 2011 (TW) 100148605

(51) Int. Cl. F21V 9/14

(52) U.S. Cl. CPC F21V 9/14
USPC 362/19

(57) ABSTRACT

An illumination module comprising a light guide member, a first light source and a first polarizing element is provided. The light guide member is a polarization-maintaining light conductor, and comprises a first end, a second end and a main body. The main body is between the first and the second end, and comprises a light emitting area and a reflective area having a plurality of microstructures. The first light source is near the first end of the light guide member. The first polarizing element is between the first end and the first light source. The light of the first light source entering the first polarizing element is separated into a first polarized light and a second polarized light different from the first polarized light. The second polarized light passing through the first polarizing element and striking the microstructures is reflected as a third polarized light emitted to the outside.

This application claims the benefit of Taiwan application Serial No. 100148605, filed Dec. 26, 2011, the subject matter of which is incorporated herein by reference.

### BACKGROUND OF THE INVENTION

1. Field of the Invention

The invention relates in general to an illumination module, and more particularly to an anti-glare illumination module producing high light extraction efficiency.

2. Description of the Related Art

Many varieties of light sources are used in everyday life. Apart from the natural light such as the solar light, the artificial light such as the light emitted by fluorescent lamps and desktop lamps is also very common in daily life. The natural light and the ordinary artificial light both are a non-polarized light. In the electrical field of a non-polarized light, the oscillation direction of light is perpendicular to the proceeding direction of light, and the oscillation direction of light does not have a specific direction. The non-polarized light may cause glare and reflection which make human eyes fatigued or may even jeopardize the eyesight.

The polarized light which causes glare may be blocked by a polarizer. In other words, each light beam contains a vertical polarized light (comfortable to human eyes) and a horizontal polarized light (glare to human eyes). By blocking the horizontal polarized light which causes glare, anti-glare effect can thus be achieved.

Currently, an anti-glare illumination module is already provided according to the above principle. The anti-glare function is achieved by disposing a polarizing unit in a location from which the light beam of the illumination module is emitted to the outside. However, such design requires a large area of polarizing unit for transforming the light beam of the illumination module into a large area polarized light source, and the associated material is very expensive.

### SUMMARY OF THE INVENTION

The invention is directed to an illumination module which integrates a polarizing element and uses a specific structure to prevent glare and largely reduce material cost.

According to an embodiment of the present invention, an illumination module, comprising a light guide member, a first light source and a first polarizing element, is provided. The light guide member is substantially a polarization-maintaining light conductor, and comprises a first end, a second end and a main body. The main body is disposed between the first end and the second end, and comprises a light emitting area and a reflective area having a plurality of microstructures. The first light source is disposed near the first end of the light guide member. The first polarizing element is disposed between the first end of the light guide member and the first light source. After a light of the first light source enters the first polarizing element, the light is separated into a first polarized light and a second polarized light. The polarizing characteristics of the first polarized light and the second polarized light are not the same. After the second polarized light passes through the first polarizing element and strikes the microstructures, the second polarized light is reflected as a third polarized light emitted to the outside via the light emitting area. The polarizing characteristics of the third polarized light and the second polarized light are the same.

The above and other aspects of the invention will become better understood with regard to the following detailed description of the preferred but non-limiting embodiment(s). The following description is made with reference to the accompanying drawings.

### BRIEF DESCRIPTION OF THE DRAWINGS

FIG. 1 shows a schematic 3D diagram of an illumination module according to an embodiment of the invention;

FIG. 2 shows a schematic cross-sectional view of an illumination module according to an embodiment of the invention;

FIG. 3 shows a schematic cross-sectional view of an illumination module according to another embodiment of the invention;

FIG. 4 shows a schematic cross-sectional view of an illumination module according to an alternate embodiment of the invention.

### DETAILED DESCRIPTION OF THE INVENTION

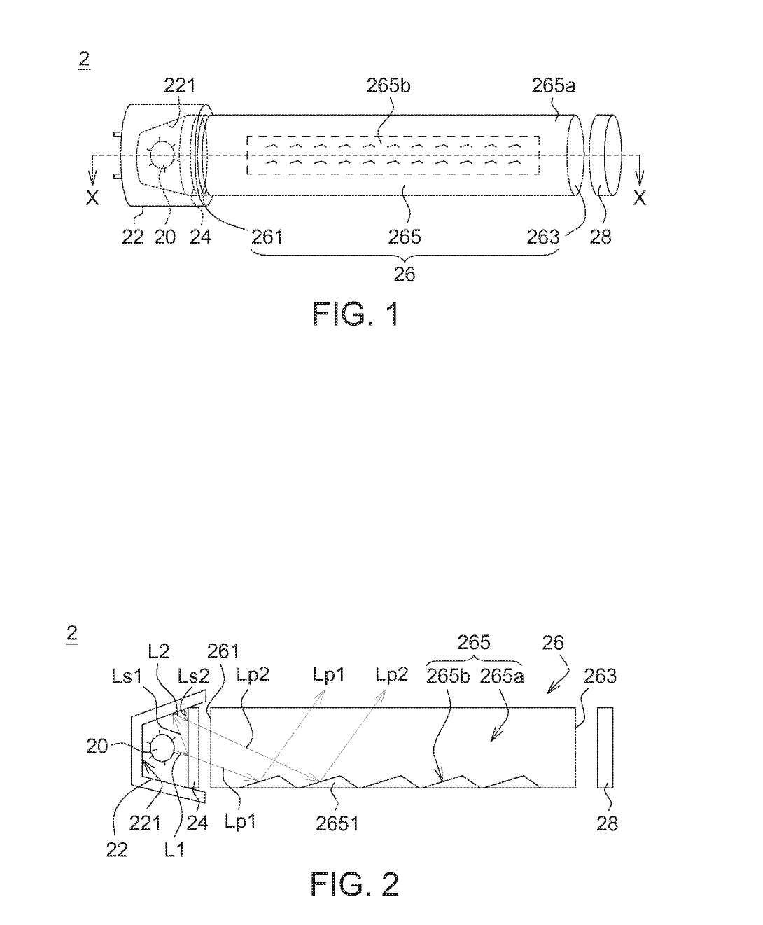

Referring to FIG. 1, a schematic 3D diagram of an illumination module 1 according to an embodiment of the invention is shown. As indicated in FIG. 1, the illumination module 2 comprises a light source 20, a reflective cavity 22, a first polarizing element 24, a light guide member 26 and a polarization-maintaining reflection member 28. The reflective cavity 22 is substantially a depolarized reflective cavity, and comprises a surface 221 realized by a non-mirror-reflection surface such as a plastic surface capable of depolarizing a polarized light. The light guide member 26 has a first end 261, a second end 263 and a main body 265. The reflective cavity 22 is mounted on the first end 261 of the light guide member 26. The light source 20 is disposed between the first end 261 of the light guide member 26 and the reflective cavity 22. The main body 265 comprises a light emitting area 265a and a reflective area 265b.

In the present embodiment, the light guide member 26 is substantially a polarization maintaining light conductor, such as a light conductor having low complex refractive index and formed by such as polymethylmethacrylate (PMMA), but the invention is not limited thereto. The main body 265 may be realized by a cylinder, an elliptical cylinder or a polygonal pillar, and the invention is not limited thereto. The bottom of the main body 265 comprises a reflective area 265b, having a plurality of microstructures such as polygonal structures. The area of the first polarizing element 24 is the same with the area of the opening of the reflective cavity 22 or the same with the area of the end surface of the first end 261 of the light guide member 26. In other words, the surface area of the first polarizing element 24 is smaller than the surface area of the light emitting area 265a of the main body 265.

Referring to FIG. 2, a schematic cross-sectional view of an illumination module 2 according to an embodiment of the invention is shown.

FIG. 2 shows a cross-sectional view of the illumination module 2 of FIG. 1 along an X-X axis. Detailed features and element structures of the illumination module 2 are already disclosed in FIG. 1, and the similarities are not repeated here. As indicated in FIG. 2, the light source 20 is disposed near the first end of the light guide member and between the first end 261 of the light guide member 26 and the reflective cavity 22. The main body 265 comprises a light emitting area 265a and a reflective area 265b having a plurality of microstructures 2651.

In the present embodiment, the microstructures 2651 are such as a V-cut structure whose surface is coated with a mirror-reflection material, a polygonal structure having mirror reflection effect or a polygonal structure having a smooth surface. The microstructures 2651 may be formed by the V-cut manufacturing process in which a plurality of V-cut microstructures 2651 is directly formed on the surface of the reflective area 265b first, and then a mirror-reflection material is coated on the surface of the V-cut microstructures 2651. Or, the microstructures 2651 may be formed by pasting a V-cut structure having mirror-reflection material on the bottom of the main body 265 directly, and the invention is not limited thereto.

In the present embodiment, the first polarizing element 24 is a reflective polarizing film such as a dual brightness enhancement film (DBEF), a polarizing beam splitter (PBS), a cholesterol liquid crystal switch having ½ wavelength, or other light splitting device capable of separating the polarized light. The shape and area of the first polarizing element 24 correspond to that of the opening of the reflective cavity 22 or that of the end surface of the first end 261 of the light guide member 26.

As indicated in FIG. 2, after a non-polarized light L1 of the light source 20 enters the first polarizing element 24, the non-polarized light L1 is separated into a first polarized light L_{S1} and a second polarized light L_{P1} by the first polarizing element 24. The first polarized light L_{S1} is such as a horizontal polarized light, and the second polarized light L_{P1} is such as a vertical polarized light. As indicated in FIG. 2, the second polarized light L_{P1} may pass through the first polarizing element 24 to enter the light guide member 26, and further strikes the surface of the microstructures 2651 via the first end 261 of the light guide member 26 to be reflected to the light emitting area 265a by the microstructures 2651 and emitted to the outside via the light emitting area 265a. Since the surface of the microstructures 2651 is a mirror coating or a smooth surface, the second polarized light L_{P1} reflected by the microstructures 2651 will not be depolarized by the same. That is, when the second polarized light L_{P1} is emitted to the outside, its polarizing characteristics are not affected by the microstructures 2651, and the second polarized light L_{P1} may retain being a vertical polarized light.

Referring to FIG. 2. In the present embodiment, the surface 221 of the first reflective cavity 22 a non-mirror-reflection surface, or a special plastic plate such as polycarbonate (PC) or poly (ethylene terephthalate) (PET) capable of depolarizing the light. After a first polarized light L_{S1} is reflected to the surface 221 of the first reflective cavity 22 by the first polarizing element 24, the first polarized light L_{S1} is depolarized as a non-polarized light L2. That is, after the first polarized light L_{S1} is reflected by the surface 221 of the first reflective cavity 22, the first polarized light L_{S1} is depolarized as a non-polarized light L2 having no specific oscillation direction in the electrical field. After the non-polarized light L2 enters the first polarizing element 24, the non-polarized light L2 is separated into a fourth polarized light L_{S2} and a fifth polarized light L_{P2}. The polarizing characteristics of the fourth polarized light L_{S2} and the first polarized light L_{S1} are the same, and the polarizing characteristics of the fifth polarized light L_{P2} and the second polarized light L_{P1} are also the same.

In the present embodiment, only the fifth polarized light L_{P2} may pass through the first polarizing element 24 to strike the surface of the microstructures 2651 of the light guide member 26, and the fifth polarized light L_{P2} is accordingly reflected to the light emitting area 265a by the microstructures 2651 to be emitted to the outside. Since the microstructures 2651 do not change the polarizing characteristics of the fifth polarized light L_{P2}, the fifth polarized light L_{P2} emitted to the outside remain being a vertical polarized light. Then, the fourth polarized light L_{S2} is reflected to the first reflective cavity 22 by the first polarizing element 24, and the fourth polarized light L_{S2} is accordingly depolarized by the surface 221 of the first reflective cavity 22. The horizontal polarized light reflected by the first polarizing element 24 is repetitively recycled to compensate for the luminance loss, which occurs when a part of the light is filtered off by the first polarizing element 24, and accordingly increase the light extraction efficiency of the anti-glare illumination module 2. Also, the illumination module 2 may further comprise a polarization-maintaining reflection member 28 (e.g. mirror-reflection film) disposed on the second end 263 of the light guide member 26 to avoid the light being leaked through the second end 263 of the light guide member 26. It should be explained that the polarization-maintaining reflection member 28 must be formed by a smooth material incapable of depolarizing the polarized light. For example, the polarization-maintaining reflection member 28 and the surface of the microstructures 2651 are both formed by the same mirror coating material.

To summarize, a first polarizing element 24 is disposed near a polarization-maintaining light guide member 26, and polarization-maintaining microstructures are disposed on the bottom of the light guide member 26, such that a point light source is transformed into a surface light source which has a much larger area and anti-glare function. More importantly, in the present embodiment, the surface area of the first polarizing element 24 only needs to be the same with the surface area of the opening of the reflective cavity 22 or the surface area of the end surface of the first end 261 of the light guide member 26, hence largely saving material cost for the first polarizing element 24. The surface area of the first polarizing element 24 is substantially the same with the surface area of the opening of the reflective cavity 22 or the same with the surface area of the end surface of the first end 261 of the light guide member 26. Besides, considering the influence of process tolerance factors, the surface area mentioned above covers the error range understandable to anyone who is skilled in the technology of the invention. Moreover, the first polarizing element 24 in conjunction with the reflective cavity 22 having depolarizing function are capable of repetitively recycling the horizontal polarized light reflected by the polarizing element 24 to compensate for the luminance loss, which occurs when a part of the light is filtered off by the first polarizing element 24, and accordingly increase the light extraction efficiency of the anti-glare illumination module 2.

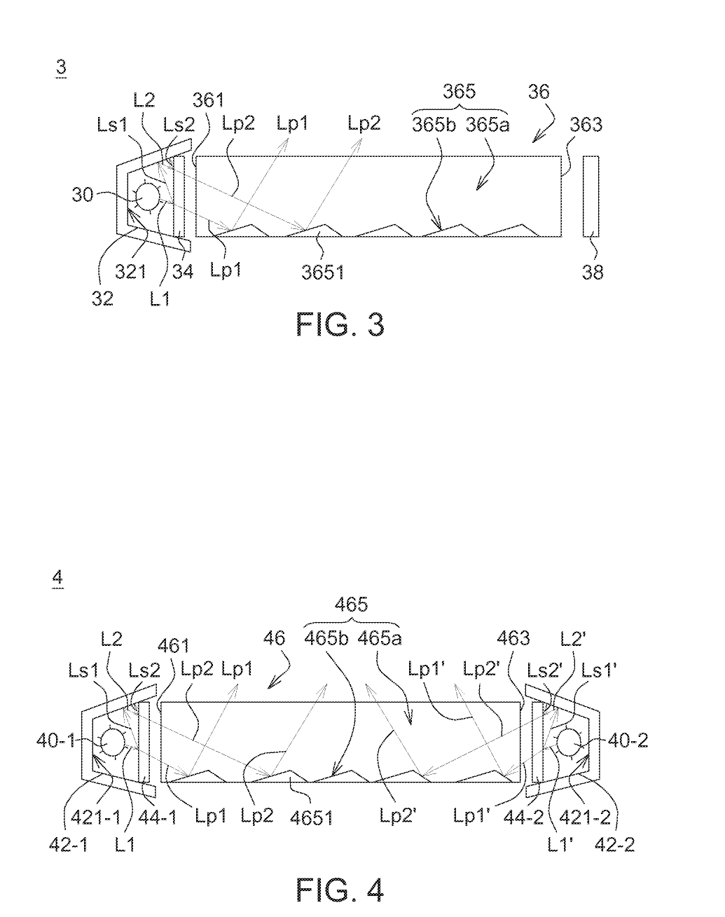

Referring to FIG. 3, a schematic cross-sectional view of an illumination module 3 according to another embodiment of the invention is shown. As indicated in FIG. 3, the illumination module 3 comprises a light source 30, a reflective cavity 32, a first polarizing element 34, a light guide member 36 and a polarization-maintaining reflection member 38. The reflective cavity 32 comprises a surface 321 such as a non-mirror-reflection surface. The light guide member 36 has a first end 361, a second end 363 and a main body 365. The reflective cavity 32 is mounted on the first end 361 of the light guide member 36, and the light source 30 is disposed between the first end 361 of the light guide member 36 and the reflective cavity 32. The main body 365 comprises a light emitting area 365a and a reflective area 365b having a plurality of microstructures 3651.

In the present embodiment, the light source 30, the reflective cavity 32, the first polarizing element 34 and the polarization-maintaining reflection member 38 are the same with corresponding elements of the illumination module 2 of FIG. 2, and the surface material of the microstructures 3651 is the same with that of the microstructures 2651. Besides, the surface 321 of the first reflective cavity 32 may be formed by the same material with the surface 221 of the first reflective cavity 22, and detailed features of the above elements are not repeated here. The optical path of the first polarized light L_{S1}, the second polarized light L_{P1}, the fourth polarized light L_{S2} and the fifth polarized light L_{P2} of the present embodiment are the same with that of the embodiment illustrated in FIG. 2, and the similarities are not repeated here.

In the present embodiment, the microstructures 3651 of the reflective area 365b are not uniformly disposed on the bottom of the light guide member 36. Since the light source 30 is disposed on the first end 361 of the light guide member 36, the distribution density of the microstructures 3651 is gradually increased from the first end 361 of the light guide member 36 in a direction towards the second end of the light guide member 363. That is, as the reflective area 365b gets closer to the first end 361 of the light guide member 36 (closer to the light source 30), the microstructures 3651 are more sparsely distributed. Relatively, as the reflective area 365b gets closer to the second end 363 of the light guide member 36 (farther away from the light source 30), the microstructures 3651 are more intensively distributed. In the present embodiment, the distribution density of the microstructures 3651 is gradually increased from the first end 361 of the light guide member 36 in a direction towards the second end of the light guide member 363, such that the light of the light source 30 striking the microstructures 3651 is reflected to the light emitting surface 365a and emitted to the outside more uniformly. Also, the distribution density of the microstructures 3651 may be adjusted according to the length of the light guide member 36 and the distance between the microstructures 3651 and light source 30, such that the light is uniformly emitted.

In the present embodiment, through the disposition of the first polarizing element 34 and the reflective cavity 32, the first polarized light L_{S1} (such as a horizontal polarized light) may be repeatedly recycled, the horizontal polarized light which may easily causes glare is depolarized and then reflected to the first polarizing element 34 again, and the second polarized light L_{P1} (such as a vertical polarized light) which does not easily cause glare is continuously separated from the reflected light. Also, through the disposition of the microstructures 3651 having different densities, the second polarized light L_{P1} which does not cause glare easily is guided to the light emitting area 365a via which the light is emitted to the outside. The horizontal polarized light reflected by the first polarizing element 34 is repetitively recycled to compensate for the luminance loss, which occurs when a part of the light is filtered off by the first polarizing element 34, and accordingly increase the light extraction efficiency of the anti-glare illumination module 3 and make the output light of the light emitting area 365a more uniformly distributed.

Referring to FIG. 4, a schematic cross-sectional view of an illumination module 4 according to an alternate embodiment of the invention is shown. As indicated in FIG. 4, the illumination module 4 comprises a first light source 40-1, a first reflective cavity 42-1, a first polarizing element 44-1, a second light source 40-2, a second reflective cavity 42-2, a second polarizing element 44-2 and a light guide member 46. The first reflective cavity 42-1 has a surface 421-1, the second reflective cavity 42-2 has a surface 421-2, wherein the surface 421-1 and the surface 421-2 are formed by the same material and are realized by such as a non-mirror-reflection surface. The light guide member 46 has a first end 461, a second end 463 and a main body 465. The first reflective cavity 42-1 is mounted on the first end 461 of the light guide member 46, and the second reflective cavity 42-2 is mounted on the second end 463 of the light guide member 46. The first light source 40-1 is disposed between the first end 461 of the light guide member 46 and the first reflective cavity 42-1, and the second light source 40-2 is disposed between the second end 463 of the light guide member 46 and the second reflective cavity 42-2. The main body 465 comprises a light emitting area 465a and a reflective area 465b having a plurality of microstructures 4651.

In the present embodiment, the first light source 40-1 is the same with the second light source 40-2, the first reflective cavity 42-1 is the same with the second reflective cavity 42-2, and the first polarizing element 44-1 is the same with the second polarizing element 44-2. The above elements are the same with corresponding elements of the illumination modules 2 and 3 of FIGS. 2 and 3, and the surface material of the microstructures 4651 is the same with that of the microstructures 2651. Moreover, the optical path and principles after the non-polarized light L1 of the first light source 40-1 enters the first polarizing element 44-1 and the non-polarized light L1′ of the light source 40-2 enters the first polarizing element 44-2 are the same with that on which FIG. 2 is based. In the present embodiment, the functions of the first polarized light L_{S1}, the another first polarized light L_{S1′}, the second polarized light L_{P1}, the another second polarized light L_{P1′}, the fourth polarized light L_{S2}, the another fourth polarized light L_{S2′}, the fifth polarized light L_{P2} and the another fifth polarized light L_{P2′} are the same with that of the embodiment in FIG. 2, and detailed features are not repeated here.

In the present embodiment, the microstructures 4651 of the reflective area 465b are not uniformly disposed on the bottom of the light guide member 46. Since the first light source 40-1 is disposed on the first end 461 of the light guide member 46 and the second light source 40-2 is disposed on the second end 463 of the light guide member 46, the microstructures 4651 are sparsely disposed at the first end 461 and the second end of the light guide member 46 which are close to the light sources 40-1 and 40-2, and the microstructures 4651 are compactly disposed at the center of the light guide member 46 which is away from the light sources 40-1 and 40-2. As the distribution density of the microstructures 4651 is gradually increased from the first end 461 and the second end 463 of the light guide member 46 in a direction towards the center of the light guide member 46, the incident lights of the light sources 40-1 and 40-2 entering the microstructures 4651 are reflected to the light emitting surface 465a and emitted to the outside more uniformly. Also, the distribution density of the microstructures 4651 may be adjusted according to the length of the light guide member 46 and the distance between the microstructures 4651 and the light sources 40-1 and 40-2, such that the light is uniformly emitted.

Referring to FIG. 4, In the present embodiment, both the first polarized light L_{S1} and the another first polarized light L_{S1′} are such as a horizontal polarized light, and both the second polarized light L_{P1} and the another second polarized light L_{P1′} are such as a vertical polarized light. Moreover, the polarizing characteristics of the fourth polarized light L_{S2} and the another fourth polarized light L_{S2′} and the first polarized light L_{S1} are the same. The polarizing characteristics of the fifth polarized light L_{P2} and the another fifth polarized light L_{P2′} and the second polarized light L_{P1} are also the same. Since the surface of the microstructures 4651 is a mirror coating or a smooth surface, the second polarized light L_{P1} and the another second polarized light L_{P1′} when reflected by the microstructures 4651 are not depolarized by the microstructures 4651. Furthermore, the fifth polarized light L_{P2} and the another fifth polarized light L_{P2′} when reflected by the microstructures 4651 are not depolarized by the microstructures 4651, such that the outputted second polarized light L_{P1}, another second polarized light L_{P1′}, fifth polarized light L_{P2} and another fifth polarized light L_{P2′} remain being a vertical polarized light.

In the present embodiment, the fourth polarized light L_{S2} and the another fourth polarized light L_{S2′} are reflected to the first and the second reflective cavities 42-1 and 42-2 by the first and the second polarizing elements 44-1 and 44-2 respectively. After the fourth polarized light L_{S2} and the another fourth polarized light L_{S2′} are depolarized by the surface 421-1 of the first reflective cavity 42-1 and the surface 421-2 of the second reflective cavity 42-2 respectively, the fourth polarized light L_{S2} and the another fourth polarized light L_{S2′} enter the first polarizing element 44-1 and the second polarizing element 44-2 respectively. The horizontal polarized light reflected by the first and the second polarizing elements 44-1 and 44-2 is repetitively recycled to compensate for the luminance loss, which occurs when a part of the light is filtered off by the first and the second polarizing elements 44-1 and 44-2, and accordingly increase the light extraction efficiency of the anti-glare illumination module 4.

In the present embodiment, through the disposition of the first and the second polarizing elements 44-1 and 44-2, the first and the second reflective cavities 42-1 and 42-2, the horizontal polarized light which may easily causes glare is depolarized and then reflected to the first and the second polarizing elements 44-1 and 44-2 respectively to continuously separate the second polarized light L_{P1} and the another second polarized light L_{P1′} (such as a vertical polarized light) from the reflected light. Also, through the disposition of microstructures 4651 having different densities, the second polarized light L_{P1} and the another second polarized light L_{P1′} which do not easily cause glare are guided to the light emitting area 465a to be emitted to the outside, such that the output light of the light emitting area 465a is more uniformly distributed.

To summarize, the illumination module of the above embodiments of the invention, special polarizing element is used to separate the first polarized light which easily causes glare from the second polarized light which does not easily cause glare. Besides, by adjusting the interval between the microstructures of the reflective area, the second polarized light passing through the polarizing element is uniformly reflected and emitted to the outside. Also, through the disposition of a reflective cavity, the first polarized light reflected by the polarizing element may be recycled and used. In addition, the optical film having polarizing characteristics is expensive. By using the polarizing element whose area is substantially the same with that of the opening of the reflective cavity or the same with that of the end surface of the light guide member, the illumination module of the above embodiments of the invention may block the first polarized light which easily causes glare and emit the second polarized light which does not easily cause glare to the outside, and may compensate for the luminance loss, which occurs when a part of the light is filtered off by the first polarizing element, and accordingly increase the light extraction efficiency of the anti-glare illumination module such that the output light of the light emitting area is more uniformly distributed.

When the light extraction efficiency is not taken into consideration, the polarizing element of the above embodiments may also adopt a non-reflective light splitting device such as an ordinary polarizer to form an anti-glare surface light source. In the above embodiments, the reflective cavity may also be omitted. For example, the light source may be disposed close to the light guide member or in a recess of the light guide member.

While the invention has been described by way of example and in terms of the preferred embodiment(s), it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. An illumination module, comprising:
a light guide member substantially being a polarization-maintaining light conductor, wherein the light guide member comprises a first end, a second end and a main body disposed between the first end and the second end, and the main body comprises a light emitting area and a reflective area having a plurality of microstructures;
a first light source disposed near the first end of the light guide member; and
a first polarizing element disposed between the first end of the light guide member and the first light source, wherein, after a light of the first light source enters the first polarizing element, the light is separated into a first polarized light and a second polarized light, the polarizing characteristics of the first polarized light and the second polarized light are not the same, after the second polarized light passes through the first polarizing element and strikes the microstructures, the second polarized light is reflected as a third polarized light emitted to the outside via the light emitting area, and the polarizing characteristics of the third polarized light and the second polarized light are the same.

2. The illumination module according to claim 1, further comprising a first reflective cavity mounted on the first end of the light guide member, wherein the first light source is disposed within the first reflective cavity substantially being a depolarized reflective cavity, after the first polarized light is reflected to the first reflective cavity by the first polarizing element, the first polarized light is depolarized as a non-polarized light and is separated into a fourth polarized light and a fifth polarized light after entering the first polarizing element, the polarizing characteristics of the fourth polarized light and the first polarized light are the same, and the polarizing characteristics of the fifth polarized light and the second polarized light are also the same.

3. The illumination module according to claim 1, wherein the microstructures comprise a plurality of polygonal structures.

4. The illumination module according to claim 1, wherein the surface of the microstructures is a smooth surface or a mirror surface.

5. The illumination module according to claim 1, wherein the distribution density of the microstructures is gradually increased from the first end of the light guide member in a direction towards the second end of the light guide member.

6. The illumination module according to claim 2, further comprising:
a second light source disposed near the second end of the light guide member; and
a second polarizing element disposed between the second end of the light guide member and the second light source, wherein, after a light of the second light source enters the second polarizing element, the light is separated into an another first polarized light and an another second polarized light, the polarizing characteristics of the another first polarized light and the another second polarized light are not the same, after the another second polarized light passes through the second polarizing element and strikes the microstructures, the another second polarized light is reflected as an another third polarized light emitted to the outside via the light emitting area, the polarizing characteristics of the another second polarized light and the another third polarized light are the same.

7. The illumination module according to claim 6, further comprising a second reflective cavity mounted on the second end of the light guide member, the second light source is disposed within the second reflective cavity substantially being a depolarized reflective cavity, after the another first polarized light is reflected to the second reflective cavity by the second polarizing element, the another first polarized light is depolarized as an another non-polarized light, and after the another non-polarized light enters the second polarizing element, the another non-polarized light is separated into an another fourth polarized light and an another fifth polarized light.

8. The illumination module according to claim 6, wherein the distribution density of the microstructures is gradually increased from the first end of the light guide member and the second end of the light guide member in a direction towards the center of the light guide member.

9. The illumination module according to claim 1, further comprising a polarization-maintaining reflection member disposed on the second end of the light guide member.

10. The illumination module according to claim 9, wherein the polarization-maintaining reflection member is a mirror-reflection film.

11. The illumination module according to claim 1, wherein the light emitting area of the main body has a first surface area, and the first polarizing element has a second surface area, the first surface area is larger than the second surface area.
